(19) United States
(12) Patent Application Publication
(10) Pub. No.: US 2019/0292998 A1
(43) Pub. Date: Sep. 26, 2019

(54) METHOD AND CONTROL CIRCUIT FOR DETERMINING A MANIPULATED VARIABLE FOR ADJUSTING AN INTAKE MANIFOLD PRESSURE

(71) Applicant: VOLKSWAGEN AKTIENGESELLSCHAFT, Wolsburg (DE)

(72) Inventors: Maiko GARWON, Braunschweig (DE); Sebastian Hentzelt, Braunschweig (DE); Marco Bunjes, Isenbuttel (DE)

(73) Assignee: VOLKSWAGEN AKTIENGESELLSCHAFT, Wolfsburg (DE)

(21) Appl. No.: 16/361,678

(22) Filed: Mar. 22, 2019

(30) Foreign Application Priority Data
Mar. 22, 2018 (DE) 10 2018 106 849.2

(51) Int. Cl. F02D 9/02

(52) U.S. Cl. CPC F02D 9/02; F02D 2009/0213

(57) ABSTRACT

The present invention relates to a method for determining a manipulated variable for adjusting an intake manifold pressure in an internal combustion engine on the basis of a target intake manifold pressure, whereby the target intake manifold pressure is corrected as a function of a limit value of the manipulated variable and/or as a function of a variable that has been influenced by the limit value of the manipulated variable. Moreover, the invention relates to a control circuit for carrying out such a method.

### FIELD OF THE INVENTION

The invention relates to a method and to a control circuit for determining a manipulated variable, for example, an opening surface area of a throttle valve or a position of a throttle valve, for adjusting an intake manifold pressure in an internal combustion engine such as, for instance, an internal combustion engine of a motor vehicle.

### BACKGROUND OF THE INVENTION

When it comes to achieving efficient, comfortable and low-consumption operation of internal combustion engines, a precise adjustment of the intake manifold pressure plays an important role. However, an erroneous determination and adjustment of the intake manifold pressure can occur due to manufacturing tolerances of individual components such as the throttle valve. This can give rise, for example, to oscillating throttle valve movements in tolerance-affected components on the fresh air side, as a result of which idling occurs that is perceptible to a driver, or else this can give rise to oscillating throttle valve movements in the case of a defective system, for example, a leaky system, that were not reliably detected, leading to a toggling activation of the leakage diagnosis of the intake manifold.

These problems are caused by the so-called windup effect in a controller with an I term (integral-action component) whose manipulated variable is limited. If a target value is envisaged—in the case here a target intake manifold pressure at which the manipulated variable assumes a limit value—then the segment cannot be corrected over a prolonged period of time, as a result of which the I term rises steadily (windup). If subsequently a different target value is envisaged at which the manipulated variable assumes a value between the manipulated variable limits, then the controller can experience marked overshooting or even instability since the high I term first has to be reduced again by overshooting.

For this reason, up until now, the so-called anti-windup has been used to avoid the windup effect. Towards this end, the I term of the controller is frozen in situations in which the manipulated variable assumes a limit value, in other words, a state of the control is fixed, and a cyclical re-initialization is carried out—here, for example, in an upper or lower mechanical stop of the throttle valve. However, this does not permit a continuous operation of the control and a general re-initialization routine does not exist for all operating conditions, thus calling for extensive coordination and safeguarding efforts.

Similar solutions are also known from the realm of electric motors, as described in German patent applications DE 10 2009 000 609 A1 and DE 10 2015 118 980 A1.

### SUMMARY OF THE INVENTION

The objective of the present invention is to put forward a method and a control circuit for determining a manipulated variable for adjusting an intake manifold pressure, which at least partially overcome the above-mentioned drawbacks.

This objective is achieved by means of the method according to the invention for determining a manipulated variable for adjusting an intake manifold pressure as claimed and by means of the control circuit according to the invention as claimed.

According to a first aspect, the invention relates to a method for determining a manipulated variable for adjusting an intake manifold pressure in an internal combustion engine on the basis of a target intake manifold pressure, whereby the target intake manifold pressure is corrected as a function of a limit value of the manipulated variable and/or as a function of a variable that has been influenced by the limit value of the manipulated variable.

According to a second aspect, the invention relates to a control circuit for determining a manipulated variable for adjusting an intake manifold pressure in an internal combustion engine on the basis of a target intake manifold pressure, whereby the control circuit comprises a correction unit for correcting the target intake manifold pressure as a function of a limit value of the manipulated variable and/or as a function of a variable that has been influenced by the limit value of the manipulated variable.

Additional advantageous configurations of the invention ensue from the subordinate claims and from the description below of preferred embodiments of the present invention.

The present invention relates to a method for determining a manipulated variable for adjusting an intake manifold pressure in an internal combustion engine. The manipulated variable can be, for example, an opening surface area of the throttle valve (leakage surface area of the throttle valve) or a position of a throttle valve that is arranged in the intake manifold. The internal combustion engine can be an internal combustion engine of a motor vehicle, for instance, a gasoline engine or a diesel engine.

In order to determine the manipulated variable, a target intake manifold pressure is assumed that has preferably been determined as a function of a current operating situation of the internal combustion engine and as a function of a request made by the driver. In the method according to the invention, the target intake manifold pressure is then corrected as a function of a limit value of the manipulated variable, preferably an upper limit value of the manipulated variable and a lower limit value of the manipulated variable, and/or as a function of a variable that has been influenced by a limit value of the manipulated variable, preferably a variable that has been influenced by the upper limit value of the manipulated variable and by the lower limit value of the manipulated variable. The limit value of the manipulated variable, especially the upper limit value of the manipulated variable and the lower limit value of the manipulated variable, can be specified by a configuration of the internal combustion engine, especially by a configuration of the throttle valve as well as, if applicable, by an arrangement of the throttle valve in the intake manifold.

The correction of the target intake manifold pressure as a function of the limit value of the manipulated variable and/or as a function of a variable that has been influenced by the limit value of the manipulated variable can limit the target intake manifold pressure in such a way that manipulated variable values that fall outside of the manipulated variable limits are no longer aimed for. Therefore, the invention puts forward a method for the continuous operation of a non-linear pressure control by means of a throttled range while avoiding a windup of an integrator in the control circuit. Consequently, a re-initialization routine with all of the attendant drawbacks is superfluous and the application and safeguarding efforts can be drastically reduced.

In some embodiments, the limit value of the manipulated variable can comprise a maximum opening surface area of the throttle valve in the intake manifold and/or a minimum opening surface area of the throttle valve. Preferably, the upper limit value of the manipulated variable is the maximum opening surface area of the throttle valve while the lower limit value of the manipulated variable is the minimum opening surface area of the throttle valve. As an alternative, the limit value of the manipulated variable can comprise a first position of the throttle valve in which the throttle valve is maximally opened and/or a second position of the throttle valve in which the throttle valve is maximally closed. In the first position of the throttle valve, the throttle valve can be opened to such an extent that the opening surface area of the throttle valve amounts to at least 90% of the cross sectional surface area of the intake manifold. In the second position of the throttle valve, the throttle valve can still be slightly open, for example, at the maximum by 5%, especially by 2%, of a complete opening of the throttle valve in the first position of the throttle valve.

The variable that has been influenced by the limit value of the manipulated variable can be a variable containing an opening surface area of the throttle valve that has been limited by the maximum opening surface area of the throttle valve and/or by the minimum opening surface area of the throttle valve. As an alternative, the variable that has been influenced by the manipulated variable can be a variable containing a position of the throttle valve that has been limited by the first position of the throttle valve and/or by the second position of the throttle valve.

When a manipulated variable is being limited, it can be checked whether the value of the manipulated variable is greater than the upper limit value of the manipulated variable, and if this is the case, the manipulated variable can be set so as to be equal to the upper limit value of the manipulated variable. If this is not the case, it can be checked whether the value of the manipulated variable is smaller than the lower limit value of the manipulated variable, and if this is the case, the manipulated variable can be set so as to be equal to the lower limit value of the manipulated variable. If this is not the case, the manipulated variable falls within a range between the upper limit value of the manipulated variable and the lower limit value of the manipulated variable, and the manipulated variable remains unchanged. As an alternative, it can also be first checked whether the value of the manipulated variable is smaller than the lower limit value of the manipulated variable, and subsequently, whether the value of the manipulated variable is greater than the upper limit value of the manipulated variable. The limitation can also be carried out in a different way.

In some embodiments, the manipulated variable can be determined by means of a PI control (proportional-integral control) of the corrected target intake manifold pressure, by means of a non-linear transformation of the regulated target intake manifold pressure into an unlimited manipulated variable and by means of a limitation of the unlimited manipulated variable by means of the limit value of the manipulated variable. The limited manipulated variable can be a limited opening surface area of the throttle valve which, as described above, is determined by means of the limit value of the manipulated variable, especially by means of the maximum opening surface area of the throttle valve and by means of the minimum opening surface area of the throttle valve. A position of the throttle valve can be calculated on the basis of the limited opening surface area of the throttle valve. As an alternative, the limited manipulated variable can be a limited position of the throttle valve which can be limited, analogously to the limitation of the opening surface area of the throttle valve.

The PI control can follow the laws of a conventional PI controller, in other words, it can comprise determining a P term (proportional term) and an I term (integral term). The non-linear transformation can be based on a non-linear relationship for the influence that the properties or current operating conditions of the throttle valve have on the intake manifold pressure. The non-linear relationship can be influenced, for instance, by the leakage offset of the throttle valve, by the mass flow through the throttle valve, by the pressure upstream from the throttle valve and by the pressure downstream from the throttle valve. The leakage offset especially describes component tolerances in the intake manifold, particularly of the throttle valve, which can give rise to undesired oscillating throttle valve movements. The limitation, especially by means of surface area limits, in other words, the maximum opening surface area of the throttle valve and the minimum opening surface area of the throttle valve, can be carried out as described above.

In some embodiments, on the basis of the limit value of the manipulated variable or on the basis of the variable that has been influenced by the limit value of the manipulated variable, a correction value of the target intake manifold pressure to correct said target intake manifold pressure can be determined by means of a transformation. If the manipulated variable is an opening surface area of the throttle valve, then the transformation of the limit value of the manipulated variable can be an inversion analogous to an inversion of the opening surface area of the throttle valve. For example, the upper opening surface area of the throttle valve and the lower opening surface area of the throttle valve or else the limited opening surface area of the throttle valve can be inverted.

Preferably, the transformation can be an inverse transformation to the transformation of the corrected, regulated target intake manifold pressure. It can also be a transformation of the non-linear limit values of the manipulated variables—which can preferably result in a limitation of the manipulated variables—into a state range of the controller. The transformed limit value of the manipulated variables or the limitations of the manipulated variables can be employed to appropriately adjust the target intake manifold pressure of the control circuit so that windup effects are prevented.

Through the correction of the target intake manifold pressure, the cyclical oscillations of the throttle valve can be eliminated simply and effectively in case of a leakage of the throttle valve, for example, during idling. It is consequently possible to dispense with an application involving switching restrictions and re-initialization parameters.

In some embodiments, the upper limit value of the manipulated variable, especially the maximum opening surface area of the throttle valve, can be transformed into a maximally achievable intake manifold pressure, and the lower limit value of the manipulated variable, especially the minimum opening surface area of the throttle valve, can be transformed into a minimally achievable intake manifold pressure, and the target intake manifold pressure can be limited as a function of the transformed maximally achievable intake manifold pressure and as a function of the transformed minimally achievable intake manifold pressure. The limitation can be carried out analogously to the limitation described above for the opening surface area of the throttle valve. Therefore, the target intake manifold pressure can be limited to exact limits which do not allow any breach of the limitations of the manipulated variables, in other words, neither exceeding the upper limit value of the manipulated variable nor falling below the lower limit value of the manipulated variable. As a result, the performance can be improved and, at the same time, the application and safeguarding efforts can be reduced.

In some embodiments, the transformation of the maximum opening surface area of the throttle valve into the maximally achievable intake manifold pressure p^{*,max} can be based on the following relationship:

p^{*,max}=Δpₛᵣ+\tilde{p}ₛᵣ+bA_{eff}^{max} (1)

wherein Δpₛᵣ stands for a prognosticated change in the intake manifold pressure, which has preferably been determined by means of a model of the influence of the throttle valve and/or by means of a model of the intake manifold pressure and of the I controller, \tilde{p}ₛᵣ stands for a measured intake manifold pressure, b stands for a variable that is influenced by the flow through the throttle valve, by the leakage of the throttle valve, by the mass flow through the throttle valve and by the P controller, and A_{eff}^{max} stands for the maximum opening surface area of the throttle valve. In particular, the transformation can be based on the following relationship:

$${p}^{* , max} = Δ {p}_{sr} + {\tilde{p}}_{sr} + \frac{{μ}_{mult}}{36000 {K}_{4}} ( {A}_{eff}^{max} + {A}_{efcOffset} - {μ}_{off} ) \qquad ( 1 a )$$

wherein μₘᵤₗₜ stands for the flow factor through the throttle valve, K₄ stands for the reinforcement factor of the P control, A_{effOffset} stands for the leakage offset and μ_{off} stands for the mass flow through the throttle valve.

Accordingly, the transformation of the minimal opening surface area of the throttle valve into the minimally achievable intake manifold pressure p^{*,min} can be based on the following relationship:

p^{*,min}=Δpₛᵣ+\tilde{p}ₛᵣ+bA_{eff}^{min} (2)

wherein A_{eff}^{min} stands for the minimum opening surface area of the throttle valve. In particular, the transformation of the minimum opening surface area of the throttle valve can be based on the following relationship:

$${p}^{* , min} = Δ {p}_{sr} + {\tilde{p}}_{sr} + \frac{{μ}_{mult}}{36000 {K}_{4}} ( {A}_{eff}^{min} + {A}_{efcOffset} - {μ}_{off} ) \qquad ( 2 a )$$

By means of equations (1) and (2) or by means of equations (1a) and (2a), an inverse transformation of the non-linear limit value of the manipulated variables, especially of the upper limit value A_{eff}^{max} of the manipulated variable and of the lower limit value A_{eff}^{min} of the manipulated variable, can be carried out.

Analogously, the maximally achievable intake manifold pressure can be transformed from the first position of the throttle valve while the minimally achievable intake manifold pressure can be transformed from the second position of the throttle valve.

By means of inversely transformed limit values of the manipulated variables, the target intake manifold pressure can be limited to a permissible manipulated variable range and the windup effect can be reliably prevented.

In some embodiments, the difference between an unlimited manipulated variable and a limited manipulated variable, for instance, between an unlimited opening surface area of the throttle valve and the limited opening surface area of the throttle valve, can be transformed into a pressure differential and the target intake manifold pressure can be adapted as a function of the transformed pressure differential. In this manner, a continuous inverse transformation of the difference between the unlimited and the limited manipulated variables to a required target intake manifold pressure can be carried out.

In some embodiments, the following can apply for the determination of the transformed pressure differential Δp*ₛᵣ:

Δp*ₛᵣ=c(A_{efcLim}−A_{effUnLim}) (3)

wherein c stands for a variable that has been influenced by the P controller and by the flow factor through the throttle valve, A_{efcLim} stands for the limited opening surface area of the throttle valve and A_{efcUnLim} stands for the unlimited opening surface area of the throttle valve.

Preferably, the inverse transformation of non-linear unlimited and limited opening surface areas of the throttle valve can follow the relationship below:

Δp*ₛᵣ=K₅ 360000μₘᵤₗₜ(A_{efcLim}−A_{effUnLim}) (3a)

wherein K₅ stands for the reinforcement factor of the P control.

Analogously, the transformed pressure differential can also be transformed from the difference between a limited position of the throttle valve and an unlimited position of the throttle valve.

Therefore, the difference from a transformed, limited and unlimited manipulated variable can be fed back to an input of the integrator of the pressure controller. The feedback preferably leads to an algebraic loop. This, however, can be resolved by fixed-point iteration.

The correction of the target intake manifold pressure as a function of a limit value of the manipulated variable, especially the upper limit value of the manipulated variable and the lower limit value of the manipulated variable, and also as a function of the variable that has been influenced by the limit value of the manipulated variable, especially a difference from the limited and unlimited manipulated variables, is suitable to eliminate the oscillations of the throttle valve. Both concepts can constitute a negative bonanza effect.

Moreover, the present invention relates to a control circuit for determining a manipulated variable for adjusting an intake manifold pressure in an internal combustion engine on the basis of a target intake manifold pressure, whereby the control circuit comprises a correction unit for correcting the target intake manifold pressure as a function of a limit value of the manipulated variable and/or as a function of the variable that has been influenced by the limit value of the manipulated variable. For instance, the control circuit comprises a disturbance variable observer, a PI controller, a non-linear transformer, a manipulated variable limiter and the correction unit. The control circuit is preferably configured to carry out a method for determining a manipulated variable for adjusting an intake manifold pressure, as described above. The control circuit can be part of an engine control unit in the internal combustion engine of the motor vehicle. The correction of the target intake manifold pressure makes it possible to effectively prevent the occurrence of a windup effect of the integrator in the control circuit.

If the manipulated variable is the opening surface area of the throttle valve, the controller can also comprise a conversion unit to calculate the position of the throttle valve on the basis of the limited opening surface area of the throttle valve.

The control circuit can also have an adjustment unit for adjusting the determined position of the throttle valve. The intake manifold pressure is set by adjusting the position of the throttle valve.

In some embodiments, on the basis of the limit value of the manipulated variable or on the basis of the variable that has been influenced by the limit value of the manipulated variable, the control circuit can also have an inverse transformation means that is configured to determine a correction value for the target intake manifold pressure for correcting the target intake manifold pressure by means of a transformation, as is described in detail above.

The present invention is characterized by an inverse transformation of the limitation of the manipulated variables to the state space of the linear part of the controller as well as by an interaction of the entire system between the anti-windup (based on the feedback of the inverse transformation of the limited manipulated variable), the non-linear pressure controller and the parallel model of the closed control circuit including the integrator, in order to ensure the stationary precision.

### BRIEF DESCRIPTION OF THE DRAWINGS

Embodiments of the invention will now be explained by way of examples and making reference to the accompanying drawings. The following is shown:

FIG. 1: schematically, a depiction of a drive arrangement and of a control unit with a control circuit for determining an opening surface area of the throttle valve;

FIG. 2: schematically, a conventional control circuit;

FIG. 3: schematically, a first embodiment of a control circuit according to the invention, with a limitation of the target intake manifold pressure;

FIG. 4: a flow diagram of a method for determining a manipulated variable for adjusting an intake manifold pressure in an internal combustion engine, with the control circuit of the first embodiment;

FIG. 5: schematically, a second embodiment of a control circuit according to the invention, with a limitation of the target intake manifold pressure; and

FIG. 6: a flow diagram of a method for determining a manipulated variable for adjusting an intake manifold pressure in an internal combustion engine, with the control circuit of the second embodiment.

### DETAILED DESCRIPTION OF THE INVENTION

FIG. 1 shows a section of a drive arrangement 1. The drive arrangement 1 has an intake manifold 10, a throttle valve 11, an internal combustion engine 12, an exhaust gas turbocharger 13 and an exhaust gas channel 14. The throttle valve 11 is arranged in the intake manifold 10 and is configured to regulate the feed of fresh air into the internal combustion engine 12. The internal combustion engine 12 is connected to the intake manifold 10 and to the exhaust gas channel 14. The exhaust gas turbocharger 13, which is provided to regulate the charge pressure in the intake manifold 10, has a turbine 130 and a compressor 131 that is connected to the turbine 130 via a shaft. The turbine 130 is arranged in the exhaust gas channel 14 and it is driven by exhaust gas that is flowing out of the internal combustion engine 12. The compressor 131 is arranged in the intake manifold 10 and, driven by the turbine 130, it compresses the air in the intake manifold 10.

The drive arrangement 1 also comprises an engine control unit 2 that has a control circuit 20 for adjusting an intake manifold pressure.

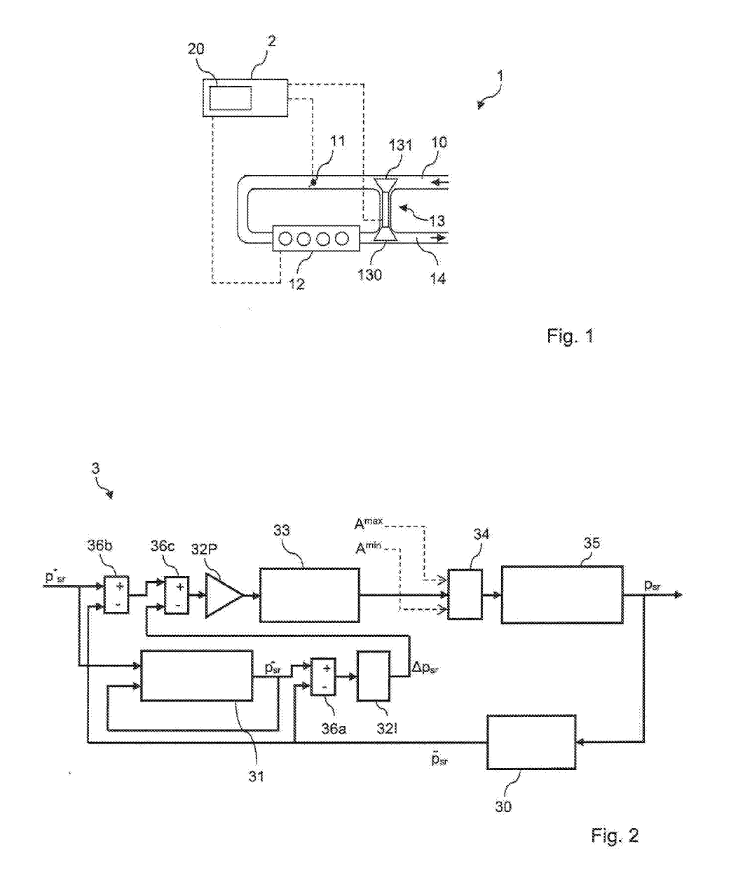

In conventional drive devices, the control circuit 20 is often configured as described with reference to FIG. 2. FIG. 2 shows a control circuit 3 with an intake manifold sensor 30, a disturbance variable observer 31, a PI controller that comprises a P controller 32P and an I controller 32I, a non-linear transformer 33, a manipulated variable limiter 34 and a conversion and adjustment unit 35.

The sensor 30 for the intake manifold pressure measures the current actual intake manifold pressure pₛᵣ and sends a measurement signal \hat{p}ₛᵣ representing the detected actual intake manifold pressure pₛᵣ to a first differentiator 36a that is situated upstream from the I controller 32I, to the disturbance variable observer 31 that is situated upstream from the first differentiator 36a, and to a second differentiator 36b.

The disturbance variable observer 31 is provided to determine an anticipated intake manifold pressure \tilde{p}ₛᵣ on the basis of a target intake manifold pressure p*ₛᵣ and on the basis of the measurement signal \hat{p}ₛᵣ by means of a model that describes the influence of the throttle valve on the intake manifold pressure as well as by means of a model of the intake manifold pressure. In this context, the anticipated intake manifold pressure \tilde{p}ₛᵣ indicates which actual intake manifold pressure will set in.

The first differentiator 36a forms a difference between the measurement signal \hat{p}ₛᵣ and the anticipated intake manifold pressure \tilde{p}ₛᵣ and forwards it to the I controller 32I. The I controller 32I subjects the difference between the measurement signal \hat{p}ₛᵣ and the anticipated intake manifold pressure \tilde{p}ₛᵣ to an integral control and forwards the result Δpₛᵣ to a third differentiator 36c that is situated downstream from the second differentiator 36b and upstream from the P controller 32P.

The second differentiator 36b forms a difference from the target intake manifold pressure p*ₛᵣ and the measurement signal \hat{p}ₛᵣ and forwards it to the third differentiator 36c. The third differentiator 36c forms a difference from the difference between the target intake manifold pressure P*ₛᵣ and the measurement signal \hat{p}ₛᵣ and the result Δpₛᵣ of the I controller and forwards the result to the P controller 32P.

The P controller 32P subjects the result of the third differentiator 36c to a proportional control and forwards the result to the non-linear transformer 33. The transformer 33 carries out a non-linear transformation in order to determine a target opening surface area of the throttle valve and forwards this target opening surface area to the manipulated variable limiter 34. By means of a maximally possible opening surface area A_{eff}^{max} of the throttle valve and a minimally possible opening surface area A_{eff}^{min} of the throttle valve, which are prescribed by the configuration of the throttle valve and by its installation in the intake manifold, the manipulated variable limiter 34 corrects the target opening surface area of the throttle valve and forwards the corrected target opening surface area of the throttle valve to the calculation and adjustment unit 35. The manipulated variable limiter 34 checks whether the target opening surface area of the throttle valve falls between the maximally possible opening surface area A_{eff}^{max} of the throttle valve and the minimally possible opening surface area A_{eff}^{min} of the throttle valve, and then adapts the opening surface area of the throttle valve only if this is not the case. On the basis of the corrected opening surface area of the throttle valve (limited opening surface area of the throttle valve), the calculation and adjustment unit 35 calculates a position of the throttle valve and then adjusts this position of the throttle valve. In this manner, the actual intake manifold pressure pₛᵣ is adjusted.

The control circuit 3 described with reference to FIG. 2 entails the drawback that, if the target intake manifold pressure tends to move towards a value at which the opening surface area of the throttle valve is greater or smaller than the maximally or minimally possible opening surface area of the throttle valve, no correction is possible over a prolonged period of time, as a result of which the I term rises steadily (windup). If the target intake manifold pressure subsequently tends to move towards a value at which the opening surface area of the throttle valve assumes a value between the maximally and minimally possible opening surface area of the throttle valve, then marked overshooting of the controller can occur since the high I term first has to be reduced once again by means of overshooting. For this reason, up until now, the I controller in the first case had to be frozen, which entails a demanding re-initialization procedure.

Below, two embodiments of a control circuit according to the invention will be described on the basis of the control circuit 3 shown in FIG. 2, and these embodiments render the freezing of the I controller and thus also the re-initialization procedure superfluous, thereby considerably simplifying the control of the intake manifold pressure.

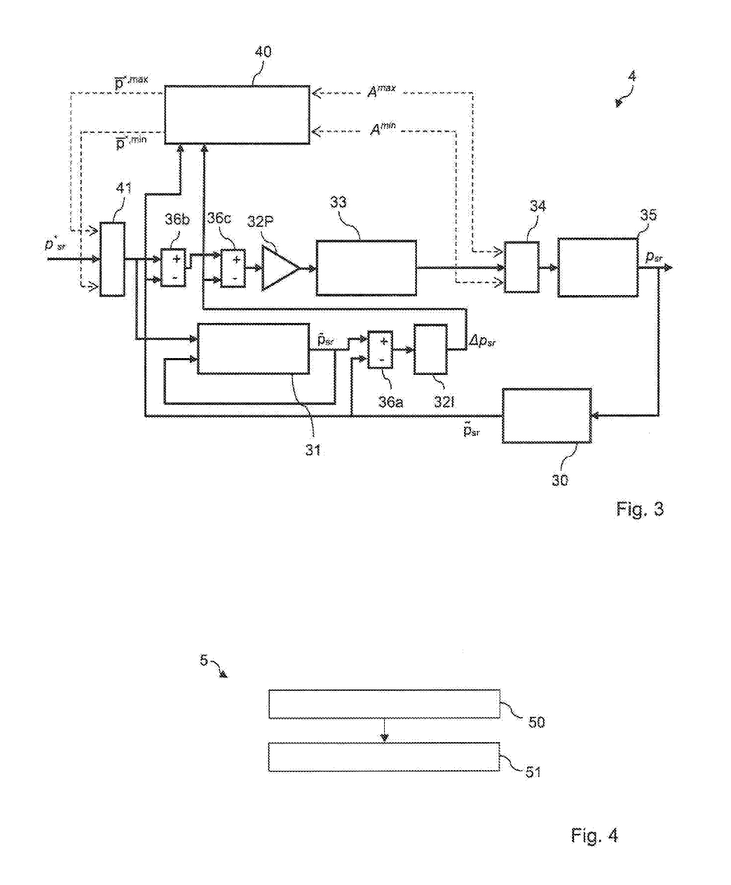

FIG. 3 shows a first embodiment of a control circuit 4 according to the invention. In addition to the components of the control circuit 3 of FIG. 2, the control circuit 4 has an inverse transformation means 40 and a target variable limiter 41. Taking into account the measurement signal \hat{p}ₛᵣ and the result Δpₛᵣ of the I controller 32I, the inverse transformation means 40 is configured to transform the maximally possible opening surface area A_{eff}^{max} of the throttle valve into a maximally achievable target intake manifold pressure p^{*,max} and to transform the minimally possible opening surface area A_{eff}^{min} of the throttle valve into a minimally achievable target intake manifold pressure p^{*,min}. The target variable limiter 41 is configured to correct the target intake manifold pressure p*ₛᵣ as a function of the maximally achievable target intake manifold pressure p^{*,max} and as a function of the minimally achievable target intake manifold pressure p^{*,min}. In this process, the target variable limiter 41 functions analogously to the manipulated variable limiter 34.

FIG. 4 shows a flow diagram of a method 5 to correct the target intake manifold pressure by means of the control circuit 4 of the first embodiment.

In 50, the maximally possible opening surface area of the throttle valve is transformed into a maximally achievable intake manifold pressure. The transformation takes place on the basis of the above-mentioned relationships

$$\begin{matrix}{p}^{* , max} = Δ {p}_{sr} + {\tilde{p}}_{sr} + \frac{{μ}_{mult}}{36000 {K}_{4}} ( {A}_{eff}^{max} + {A}_{efcOffset} - {μ}_{off} ) \\ and & ( 1 a ) \\ {p}^{* , min} = Δ {p}_{sr} + {\tilde{p}}_{sr} + \frac{{μ}_{mult}}{36000 {K}_{4}} ( {A}_{eff}^{min} + {A}_{efcOffset} - {μ}_{off} ) & ( 2 a )\end{matrix}$$

In 51, the target intake manifold pressure is limited as a function of the transformed maximally achievable intake manifold pressure p^{*,max} and as a function of the transformed minimally achievable intake manifold pressure p^{*,min}. The target variable limiter 41 checks whether the target intake manifold pressure p*ₛᵣ falls between the maximally achievable intake manifold pressure p^{*,max} and the minimally achievable intake manifold pressure p^{*,min} and it adapts the target intake manifold pressure p*ₛᵣ only if this is not the case.

Owing to the correction of the target intake manifold pressure p*ₛᵣ by means of the limitation procedure, it no longer happens that the target intake manifold pressure tends to move towards a value at which the opening surface area of the throttle valve exceeds the maximally possible opening surface area of the throttle valve or falls below the minimally possible opening surface area of the throttle valve, since an achievable opening surface area of the throttle valve or an achievable position of the throttle valve exists in order to set each corrected target intake manifold pressure. Consequently, the control circuit can be continuously corrected and freezing of the I controller as well as a re-initialization procedure become superfluous.

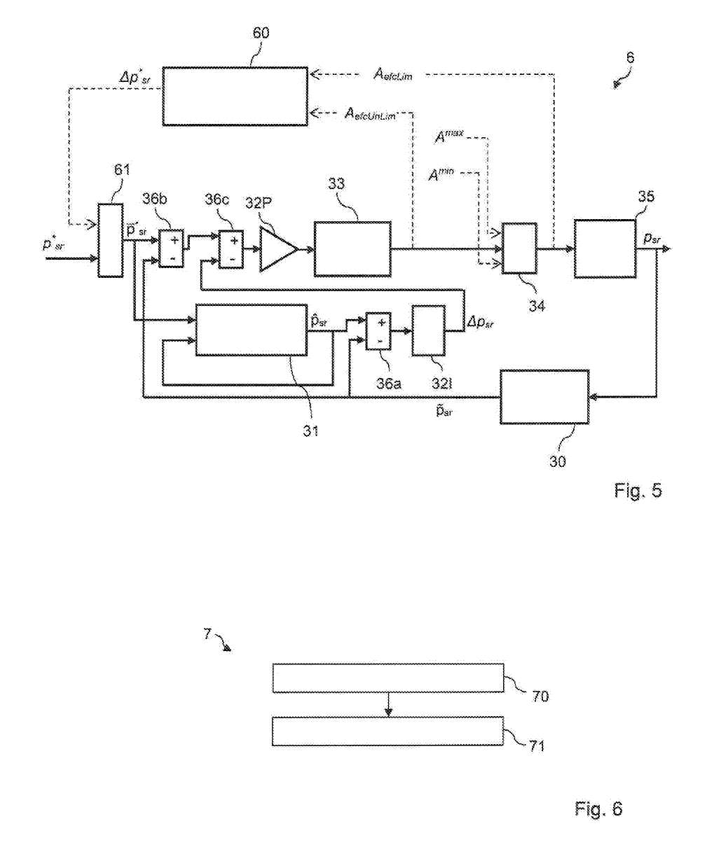

FIG. 5 shows a second embodiment of a control circuit 6 according to the invention. In addition to the components of the control circuit 3 shown in FIG. 2, the control circuit 6 comprises an inverse transformation means 60 and a correction unit 61. The inverse transformation means 60 is configured to transform a difference between the unlimited opening surface area A_{efcUnLim} of the throttle valve and the limited opening surface area A_{efcLim} of the throttle valve into a pressure differential Δp*ₛᵣ. The correction unit 61 is configured as an adder that adds the pressure differential Δp*ₛᵣ and the target intake manifold pressure p*ₛᵣ and then outputs the sum as the corrected target intake manifold pressure p̅*ₛᵣ.

FIG. 6 shows a flow diagram of a method 7 to correct the target intake manifold pressure by means of the control circuit 6 of the second embodiment.

In 70, a difference A_{efcLim}−A_{efcUnLim} between the unlimited opening surface area A_{efcLim} of the throttle valve and the limited opening surface area A_{efcUnLim} of the throttle valve is formed, and the difference A_{efcLim}−A_{efcUnLim} of the throttle valve is transformed into the pressure differential Δp*ₛᵣ in accordance with the above-mentioned relationship given below:

Δp*ₛᵣ=K₅ 360000 μₘᵤₗₜ(A_{efcLim}−A_{effUnLim}) (3a)

In 71, the sum is formed from the pressure differential Δp*ₛᵣ and the target intake manifold pressure p*ₛᵣ and then it is output as the corrected target intake manifold pressure p̅*ₛᵣ.

The inverse transformation means 60 and the correction unit 61, together with the second and third differentiators, the P controller, the non-linear transformer and the manipulated variable limiter, form an algebraic loop. If necessary, the algebraic loop can be resolved, for instance, as a fixed-point iteration.

Once again, the case in which the target intake manifold pressure tends to move towards a value at which the opening surface area of the throttle valve is greater than or smaller than the maximally or minimally possible opening surface area of the throttle valve is effectively prevented by the correction of the target intake manifold pressure p*ₛᵣ. Consequently, the control circuit can be continuously corrected and freezing of the I controller as well as a re-initialization procedure become superfluous.

### LIST OF REFERENCE NUMERALS

1 drive device
10 intake manifold
11 throttle valve
12 internal combustion engine
13 exhaust gas turbocharger
130 turbine
131 compressor
14 exhaust gas channel
2 engine control unit
20 control circuit for adjusting an intake manifold pressure
3 conventional control circuit
30 sensor for the intake manifold pressure
31 disturbance variable observer
32P P controller
32I I controller
33 non-linear transformer
34 manipulated variable limiter
35 conversion and adjustment unit
36a, 36b, 35c differentiator
4 control circuit according to the first embodiment
40 inverse transformation means
41 target variable limiter
5 method for correcting the target intake manifold pressure by means of the control circuit 4
50 transformation of the maximally and minimally possible opening surface areas of the throttle valve
51 limiting the target intake manifold pressure
6 control circuit according to the second embodiment
60 inverse transformation means
61 correction unit
7 method for correcting the target intake manifold pressure by means of the control circuit 6
70 transformation of the maximally and minimally possible opening surface areas of the throttle valve
71 limiting the target intake manifold pressure

1. A method for determining a manipulated variable for adjusting an intake manifold pressure in an internal combustion engine on the basis of a target intake manifold pressure, comprising:
correcting the target intake manifold pressure as a function of a limit value of the manipulated variable and/or as a function of a variable that has been influenced by the limit value of the manipulated variable.

2. The method according to claim 1, whereby the limit value of the manipulated variable comprises a maximum opening surface area of a throttle valve in the intake manifold and/or a minimum opening surface area of the throttle valve and/or whereby the variable that has been influenced by the limit value of the manipulated variable is a variable containing an opening surface area of the throttle valve that has been limited by the maximum opening surface area of the throttle valve and/or by the minimum opening surface area of the throttle valve.

3. The method according to claim 1, whereby the manipulated variable is determined by means of a PI control (proportional-integral control) of the corrected target intake manifold pressure, by means of a non-linear transformation of the regulated target intake manifold pressure into an unlimited manipulated variable and by means of a limitation of the unlimited manipulated variable by means of the limit value of the manipulated variable.

4. The method according to claim 1, whereby, on the basis of the limit value of the manipulated variable or on the basis of the variable that has been influenced by the limit value of the manipulated variable, a correction value of the target intake manifold pressure to correct the target intake manifold pressure is determined by means of a transformation (50, 70).

5. The method according to claim 2, whereby the maximum opening surface area of the throttle valve is transformed into a maximally achievable intake manifold pressure, and the minimum opening surface area of the throttle valve is transformed into a minimally achievable intake manifold pressure, and the target intake manifold pressure is limited as a function of the transformed maximally achievable intake manifold pressure and as a function of the transformed minimally achievable intake manifold pressure.

6. The method according to claim 1,
whereby the transformation of the maximum opening surface area of the throttle valve into the maximally achievable intake manifold pressure is based on the following relationship:
p^{*,max}=Δpₛᵣ+\tilde{p}ₛᵣ+bA_{eff}^{max}; and
whereby the transformation of the minimal opening surface area of the throttle valve into the minimally achievable intake manifold pressure is based on the following relationship:
p^{*,min}=Δpₛᵣ+\tilde{p}ₛᵣ+bA_{eff}^{min}
wherein
Δpₛᵣ stands for a prognosticated change in the intake manifold pressure,
\tilde{p}ₛᵣ stands for a measured intake manifold pressure,
b stands for a variable that is influenced by a flow through the throttle valve, by a leakage of the throttle valve, by a mass flow through the throttle valve and by the P controller,
A_{eff}^{max} stands for the maximum opening surface area of the throttle valve, and
A_{eff}^{min} stands for the minimum opening surface area of the throttle valve.

7. The method according to claim 2, whereby the difference between an unlimited opening surface area of the throttle valve and the limited opening surface area of the throttle valve is transformed into a pressure differential, and the target intake manifold pressure is adapted as a function of the transformed pressure differential.

8. The method according to claim 1, whereby the following applies for the determination of the transformed pressure differential Δp*ₛᵣ:
Δp*ₛᵣ=c(A_{efcLim}−A_{effUnLim}),
wherein
c stands for a variable that has been influenced by the P controller and by a flow factor through the throttle valve,
A_{efcLim} stands for the limited opening surface area of the throttle valve, and
A_{efcUnLim} stands for unlimited opening surface area of the throttle valve.

9. A control circuit for determining a manipulated variable for adjusting an intake manifold pressure in an internal combustion engine on the basis of a target intake manifold pressure, comprising:
a correction unit for correcting the target intake manifold pressure as a function of a limit value of the manipulated variable and/or as a function of the variable that has been influenced by the limit value of the manipulated variable.

10. The control circuit according to claim 9, which, on the basis of the limit value of the manipulated variable or on the basis of the variable that has been influenced by the limit value of the manipulated variable, also comprises an inverse transformation means that is configured to determine a correction value for the target intake manifold pressure for correcting the target intake manifold pressure by means of a transformation.
